(19) United States
(12) Patent Application Publication
(10) Pub. No.: US 2006/0250784 A1
(43) Pub. Date: Nov. 9, 2006

(54) Apparatus for providing illumination of fluid streams

(76) Inventor: Michael Langone, W. Springfield, MA (US)

Correspondence Address: MCHALE & SLAVIN, P.A., 2855 PGA BLVD, PALM BEACH GARDENS, FL, 33410, US

(21) Appl. No.: 11/228,999

(22) Filed: Sep. 16, 2005

Related U.S. Application Data
(60) Provisional application No. 60/677,474, filed on May 3, 2005.

(51) Int. Cl. F21V 33/00

(52) U.S. Cl. 362/101

(57) ABSTRACT

A lighting system for providing illumination of beverage dispensing operations. The lighting system includes a battery, a control circuit, a light source such as an LED, and a switch for actuating the light source. The lighting system is self-contained and can be removably mounted on a bottle as a ring or as a pouring spout. The lighting system provides illumination, novelty, and enhances promotion of the product being dispensed.

### FIELD OF THE INVENTION

This invention is directed to the field of dispensing liquids and, in particular, illumination of bottles and fluid streams of beverages. Claiming priority of U.S. Provisional Application 60/677,474, the contents incorporated herein by reference.

### BACKGROUND OF THE INVENTION

The food and beverage business is highly competitive. Frequently, the only real difference between competing brands of a particular product is the product branding and packaging. For a product to be noticed in a crowded marketing world it must present a clearly discernible difference. In the case of distilled spirits, the decision to purchase one particular brand over another in a drinking establishment is often made “on the spot” and immediately before the product is poured. Some of the decision factors that are involved include printed advertisements which may be posted in the area, electric signs (more common with beer products) special promotions which may include give-away items and bar or restaurant table top displays which advertise particular brands.

Carefully designed bottle labels and bottles of unusual shape are additional methods used by marketers to help promote a particular brand of beverage. The appearances of the actual beverages themselves are normally unremarkable in that they are generally colorless or lightly colored.

The prior art includes many examples of illuminating containers for varied reasons. For example, Mattice et al, U.S. Pat. No. 5,662,406, teaches the use of an electric light bulb to illuminate a baby bottle during low ambient light conditions.

Gindi, U.S. Pat. No. 6,588,435, and British patent GB239827, to Townsend, teach the use of LEDs mounted on or in containers, carrying cosmetics or perfume, and actuated by a touch or movement of the cap to illuminate the container.

Published Patent Application, Pub. No. US 2005/0056663 to Yu and Pub. No. US 2005/0083676 to VanderSchuit, teach the use of LEDs to illuminate cosmetic containers and labels on various articles, respectively. The LEDs are activated by manual switches.

U.S. Pat. No. 4,229,893 to Uys Naude and U.S. Pat. No. 6,409,046 to Peckels teach the use of a lighted pouring spout that illuminates when a drink is poured from a beverage container.

What is lacking in the art is a means for illuminating a bottle and/or the fluid dispensed therefrom.

### SUMMARY OF THE INVENTION

Disclosed is a lighting system for beverage dispensing operations. Illumination is provided by use of pouring spout having a battery, a control circuit, a light source such as an LED, and a means for actuating the light source. The lighting system is self-contained and can be removably mounted on a bottle as a ring or as a pouring spout. The light can be switched on to illuminate the bottle or, the bottle and the fluid, or illumination of the fluid as it is dispensed from a bottle, or all three modes.

Therefore, it is an objective of this invention to provide an economical means to increase awareness of a particular beverage brand as a useful marketing aid.

It is a further objective of this invention to provide an apparatus to draw attention to the product each time the product is served.

It is another objective of this invention to provide a lighting system to illuminate the bottle and contents being dispensed.

Yet another objective of this invention is to provide an economical, compact and effective means to provide illumination of streams of beverages while being dispensed. Additionally, the device may provide a means of illumination of printed, embossed or other indicia on pour spouts and beverage bottles.

A still further objective of this invention is to provide a lighting system operatively coupled to a power source and an activation switch. All of these components may be located entirely internal to a dispensing head or pour spout which is designed to be attached to a beverage bottle. The light source is preferably oriented in such a manner that nearly all of the light produced by the device is coupled to the liquid stream. Additionally, it is desirable that a significant portion of the rays of light emanating from the light generating means be coupled to the liquid stream such that the total internal reflection within the liquid stream itself causes the liquid stream to function as a light guide.

Another objective is to include a timer in the circuit to illuminate for a period necessary to pour a measured shot.

Other objectives and advantages of this invention will become apparent from the following description taken in conjunction with any accompanying drawings wherein are set forth, by way of illustration and example, certain embodiments of this invention. Any drawings contained herein constitute a part of this specification and include exemplary embodiments of the present invention and illustrate various objects and features thereof.

### BRIEF DESCRIPTION OF THE FIGURES

FIG. 1 shows an isometric view of one embodiment of the device of the instant invention;

FIG. 2 is a sectioned view of one embodiment of the device of the instant invention;

FIG. 3 is an isometric exploded view showing the dispensing portion of the device detached from the plug portion of the device;

FIG. 4 shows the device of the instant invention in application;

FIG. 5 is an isometric exploded view showing the lighting system in relation to a bottle; and

FIG. 6 is an isometric side view showing a dispensing rack with a lighting system.

### DETAILED DESCRIPTION OF THE INVENTION

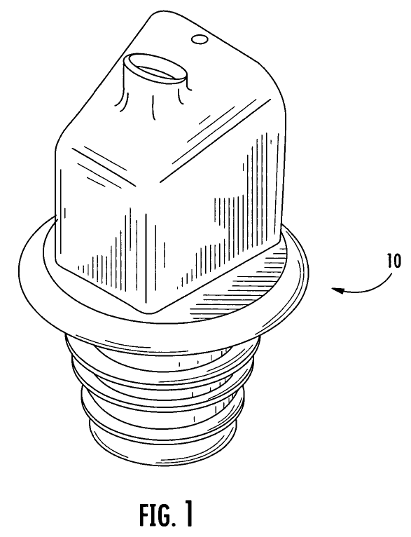

Now, referring to FIG. 1, the illumination system 10 has a pouring dispenser designed to be fitted to the neck of a container, such as a liquor bottle. Preferably, a friction fit is employed to secure the pouring dispenser to the bottle. The pouring dispenser may be of most any suitable material for handling of fluids with a preferred embodiment of the instant invention constructed from a polymer such as a thermoplastic resin.

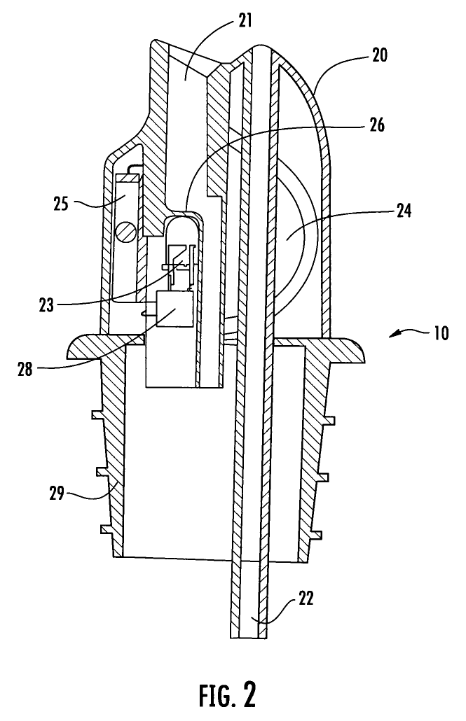

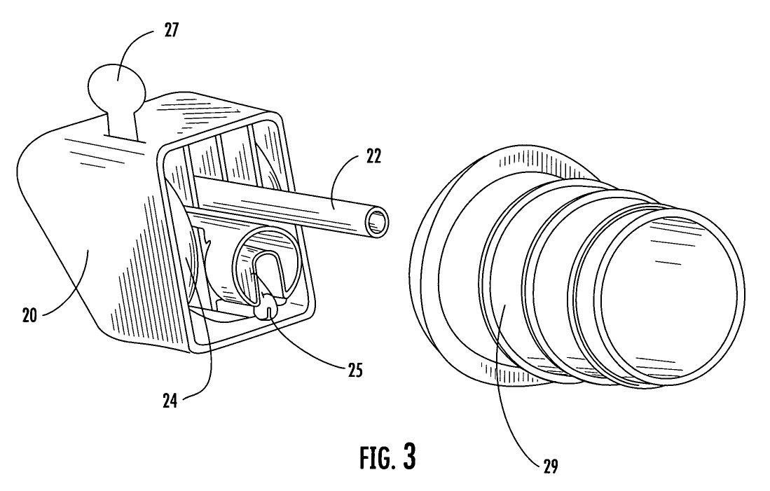

FIGS. 2 and 3 detail one possible embodiment of the instant invention and show various components which comprise it. The dispensing spout body is preferably produced by injection molding of thermoplastic resin. Any number of molded subassemblies as may be required to complete the assembly are envisioned. The device may be produced by molding or other suitable method of fabrication of any number of parts.

The attached figures illustrate an embodiment employing two molded parts. The plug portion 29 is preferably produced from the same material as the dispensing portion 20 so that these parts may be readily joined into assembly. A fluid path 21 permits beverage to flow through the device during the dispensing process. Air return port 22 permits air to flow into the bottle to replace the beverage dispensed. A light device 23 is coupled to power source 24 which may comprise at least one battery. Activation switch 25, shown here as a ball and tube switch, completes the electrical circuit when the bottle and dispensing spout are tilted to dispense the beverage, thereby causing the light 23 to produce illumination. A substantial portion of this light passes through window 26 and is absorbed in the beverage flowing in fluid path 21.

If it is desired that the light produced by light 23 not shine through certain portions of the device, these portions of the device may be fabricated of an opaque material or otherwise made opaque for example, by application of surface coating, decal or other covering. In this case, window 26 may comprise a separate component from the remainder so that it may be produced from a light transmissive material.

Similarly, window 26 may be omitted entirely and light 23 may be permitted to come into contact with the fluid to be illuminated which flows through fluid path 21. This would require that that portion of light 23 which will be wetted, be compatible with the fluid to be employed. Suffice it to say that all wetted materials of the device of the instant invention must be suitable for contact with the fluid to be illuminated.

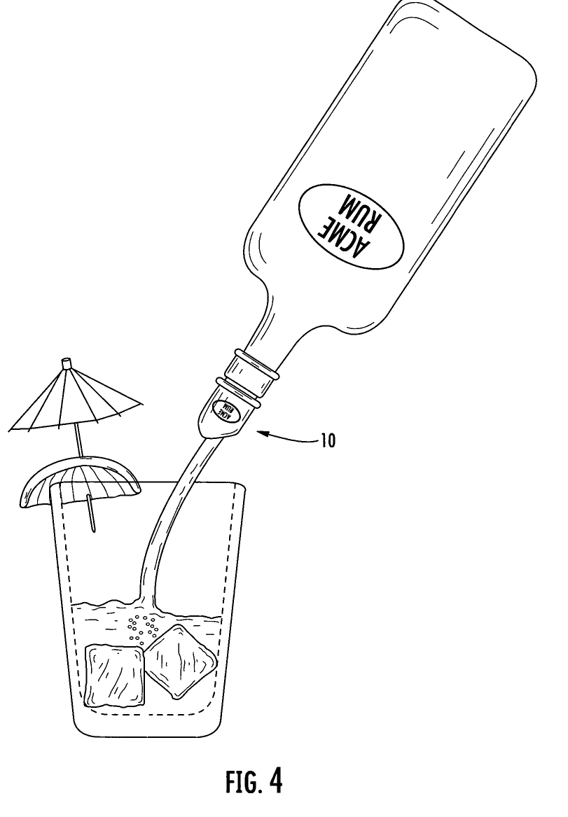

Ideally, the beam of light produced by light 23 is coaxial with the fluid stream exiting the device. This light remains more or less trapped within the flowing beverage stream as it emanates from the dispenser and flows into the drinking glass as illustrated in FIG. 4.

Fluid perturbations and bubbles in the liquid stream will cause a portion of the light contained within the fluid stream to be leaked from the stream thereby producing a dramatic light display. As the surface of the fluid stream fluctuates, this light will appear to flicker and dance. When the fluid stream reaches the beverage glass and the fluid stream becomes distorted, significant amounts of light will be released from the liquid beverage thereby causing the beverage in the glass to “glow” while the beverage is being poured.

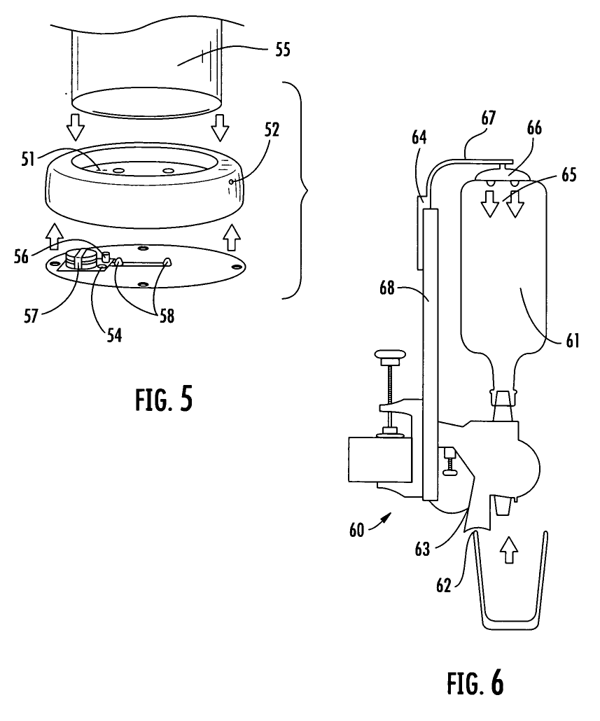

Additionally, some of the light from the light 23 may be permitted to illuminate from within, a logo or other design which may be incorporated into a portion of the beverage pouring dispenser. Further, a portion of the illumination or alternately, a second light may be employed to illuminate the beverage container (bottle) from within, as shown in FIGS. 5 and 6, thereby illuminating the beverage bottle label from behind. Such illumination of the bottle label, the logo (if any) on the pour dispenser and the stream of the actual beverage itself is highly visible and draws great interest to the product being served.

While the light 23 may be any suitable device, an LED is preferred since LEDs are compact, rugged and energy efficient. Additionally, LEDs are available in virtually all colors, as well as ultraviolet. It is anticipated that the light source may be capable of generating a plurality of colors such as may be generated by a multicolored LED which colors may be controlled by the electric circuit. Further, the light source may be steady or caused to flash or pulse in an interesting pattern. A single color light source could be employed. It is further anticipated that an ultraviolet LED could be employed to cause fluorescent materials, such as the container, the container label or the product to be dispensed, to glow.

Also illustrated in FIG. 4 is the ability of the device to provide illumination for indicia on the dispenser as well as the beverage bottle. Once again, any combination of colors of light sources may be employed in a pattern, as may be desired. For example, the color of the light used to illuminate the beverage stream may be red while the color of the light used to illuminate the bottle label may be blue.

A pull-tab, 27 as illustrated in FIG. 3 which interrupts the electrical circuit may be employed to prevent the device from inadvertent operation during storage and shipment, thereby prolonging the life of the power source.

A control circuit 28 as shown in FIG. 2 may be provided which employs any known means such as a micro-control unit, chip or other suitable circuit to interrupt, modulate or otherwise control the flow of energy from power source 24 to light 23 to produce a pattern of illumination.

Activator 25 may be a switch or other sensing device which triggers or otherwise controls action of control circuit and thereby energizes light generation by light 23. Light 23 may comprise a plurality of light sources such as LEDs of multiple colors, for example, red, blue and green. Control of the relative apparent brightness ratios of these LEDs permits generation of an infinite variety of colors. Relative brightness may be controlled either by direct current control or by pulse width control.

Activation may comprise a contact closure that is triggered when the bottle is inverted during the pouring process. One suitable switch for this application consists of a small metal ball in a tube that provides c contact closure when properly oriented. Further, the activation may include a mechanical motion switch, a touch activated switch, a pressure activated switch, a pressure activated switch or a liquid contact switch. The activation means listed are for illustrative purposes and should not be interpreted as limiting.

Another embodiment is illustrated in FIG. 5 for illuminating individual bottles. A base 50 has a thin disk 51 recessed in and surrounded by a thicker ring 52. The disk and the ring may be of a flexible polymer that is translucent, transparent or opaque. The diameter of the ring may be constant or one side may be of a different size than the other. One side is formed to frictionally engage the bottom of a standard beverage bottle 55, eg. 750 ml, and the ring is of sufficient strength to support the bottle in the upright position.

The recessed disk 51 supports a circuit board 52 which carries the electric/electronic circuit 54, the switch 56, the battery 57 and the light source 58. The circuit, battery, switch, and light source are the same as discussed above. Preferably, the switch is a simple tilt switch. The recessed disk may have apertures 53 therethrough to accommodate the light source, if it does not transmit light.

As the bottle is turned upside down to pour a drink, the tilt switch activates the light source and the interior of the bottle and liquid is illuminated in any pre-programmed pattern of lights until the bottle is returned to its upright position. The illumination may continue by timer, if desired.

The embodiment, shown in FIG. 6, may be used with bottles disposed upside down in a pouring rack 60. These conventional racks may require the bottle 61 to be tilted from the vertical to pour or a valve on the pouring spout must be opened in some other manner. As shown, the lip 62 of the glass is in contact with the valve mechanism 63. In either case, the operation of the apparatus to begin flow also initiates the switch to activate the light through the control circuit. The control circuit and battery may be disposed in housing 64 and connected to the lights 65 in cap 66 to illuminate the contents of the bottle from the bottom. The cap 66 is held in place by arm 67 which extends from the housing to the cap. The housing 64 is supported by the rod 68.

The lighting system may be used with other dispensers such as medicaments. Not only could the illuminator determine contents and flow but could serve as inducement to use the medicament. It this embodiment, it is contemplated that a medicine bottle includes such a lighting technique by either lighting the flow from the bottle onto a teaspoon, e.g. cough syrup, or lighting the fluid flow of a straw like apparatus that a child might take directly into their mouth.

All patents mentioned in this specification are indicative of the levels of those skilled in the art to which the invention pertains.

It is to be understood that while certain forms of the invention is illustrated, it is not to be limited to the specific form or arrangement herein described and shown. It will be apparent to those skilled in the art that various changes may be made without departing from the scope of the invention and the invention is not to be considered limited to what is shown and described in the specification and any drawings/figures included herein.

One skilled in the art will readily appreciate that the present invention is well adapted to carry out the objectives and obtain the ends and advantages mentioned, as well as those inherent therein. The embodiments and techniques described herein are presently representative of the preferred embodiments, are intended to be exemplary and are not intended as limitations on the scope. Changes therein and other uses will occur to those skilled in the art which are encompassed within the spirit of the invention and are defined by the scope of the appended claims. Although the invention has been described in connection with specific preferred embodiments, it should be understood that the invention as claimed should not be unduly limited to such specific embodiments. Indeed, various modifications of the described modes for carrying out the invention which are obvious to those skilled in the art are intended to be within the scope of the following claims.

What is claimed is:

1. A lighting system adapted to be mounted on a bottle for illuminating the contents of said bottle, said lighting system including a power source, a control circuit, a light source and a switch operatively interconnected, activation of said switch energizing said light source to illuminate said bottle.

2. A lighting system of claim 1 wherein said switch is a tilt switch such that tilting of said lighting system activates said light source.

3. A lighting system of claim 1 wherein said switch is a push button such that application of external pressure upon said push button activates said light source.

4. A lighting system of claim 1 wherein said switch is defined as liquid sensitive contacts such that liquid flowing over said contacts activates said light source.

5. A lighting system of claim 1 wherein said control circuit includes a timer causing deactivation of said light source after a predetermined time period.

6. A lighting system of claim 1 wherein said light source is at least one LED.

7. A lighting system of claim 1 wherein said light source is a plurality of LEDs.

8. A lighting system of claim 7 wherein said control circuit energizes said plurality of LEDs in a pattern.

9. A lighting system of claim 7 wherein some of said plurality of LEDs produce a different color light.

10. A lighting system of claim 1 wherein said bottle includes a mouth through which the contents are dispensed, said light source is aligned with said bottle and said mouth, the illumination being coaxial with the dispensed contents whereby said dispensed contents acts as a light guide.

11. A lighting system of claim 10 wherein said bottle has a bottom opposite said mouth, said light source adapted to be mounted on said bottom.

12. A lighting system of claim 10 wherein said lighting system includes a ring adapted to encircle said bottom of said bottle, said power source, said control circuit, said light source and said switch disposed in said ring.

13. A lighting system of claim 10 wherein said bottle is adapted to be supported upside down by a rack, said lighting system adapted to be attached to said rack, said lighting system including an elongated rod extending parallel with said bottle, a transverse arm normal to said rod, said arm terminating in a cap adapted to contact said bottom, said light source carried by said cap.

14. A lighting system of claim 1 wherein said lighting system includes a pouring spout adapted to be held in said mouth, said power source, said control circuit, said light source and said switch mounted in said pouring spout.

15. In a combination of a bottle and a pouring spout mounted on the mouth of the bottle and connected with the interior of said bottle for dispensing the contents from said interior, the improvement comprising a lighting system mounted on said bottle for illuminating said bottle, said lighting system having a light source and a switch operatively interconnected, activation of said switch energizing said light source to illuminate said bottle.

16. The combination of claim 15, said improvement further comprising said lighting system carried by said pouring spout, the illumination being coaxial with the dispensed contents whereby said dispensed contents acts as a light guide.

17. A lighting system of claim 15 wherein said switch is a tilt switch such that tilting of said lighting system activates said light source.

18. A lighting system of claim 15 wherein said switch is a push button such that application of external pressure upon said push button activates said light source.

19. A lighting system of claim 15 wherein said switch is defined as liquid sensitive contacts such that liquid flowing over said contacts activates said light source.

20. A lighting system of claim 15 wherein said control circuit includes a timer causing deactivation of said light source after a predetermined time period.

21. A lighting system of claim 15 wherein said light source is at least one LED.

22. A lighting system of claim 15 wherein said light source is a plurality of LEDs.

23. A lighting system of claim 15 wherein said control circuit energizes said plurality of LEDs in a pattern.

24. A lighting system of claim 15 wherein some of said plurality of LEDs produce a different color light.

25. The combination of claim 15, wherein said bottle has a closed bottom, said improvement further comprising a ring adapted to encircle said bottom, said power source, said control circuit, said light source and said switch carried by said ring.

26. A lighting system adapted to be mounted on a bottle, said bottle including a mouth through which fluid is dispensed, said lighting system including a power source, a control circuit, a light source and a switch operatively interconnected, activation of said switch energizing said light source to illuminate said fluid as it dispensed whereby said fluid acts as a light guide.

27. A lighting system of claim 26 wherein said switch is a tilt switch such that tilting of said lighting system activates said light source.

28. A lighting system of claim 26 wherein said switch is a push button such that application of external pressure upon said push button activates said light source.

29. A lighting system of claim 26 wherein said switch is defined as liquid sensitive contacts wherein said fluid activates said light source.

30. A lighting system of claim 26 wherein said control circuit includes a timer causing deactivation of said light source after a predetermined time period.

31. A lighting system of claim 26 wherein said light source is at least one LED.
